(19) United States
(12) Patent Application Publication
(10) Pub. No.: US 2017/0102749 A1
(43) Pub. Date: Apr. 13, 2017

(54) MANAGEMENT SYSTEM AND METHOD FOR DISPLAY CARD AND POWER SUPPLY

(71) Applicant: EVGA CORPORATION, New Taipei City (TW)

(72) Inventor: TAI-SHENG HAN, New Taipei City (TW)

(21) Appl. No.: 14/881,161

(22) Filed: Oct. 13, 2015

(51) Int. Cl. G06F 1/26

(52) U.S. Cl. CPC G06F 1/26

(57) ABSTRACT

For a computer host installed with a power supply, and a display card, the management system and method detects at least an electrical signal from at least a power supply and at least a display card through a detection module. Then an operation state is determined based on a user requirement and the at least one electrical signal through a control module. The power supply and the display card are adjusted to operate according to the operation state through an operation module under the control of the control module. With the present invention, a single common application programming interface integrates the management of the power supply and the display card, and the computer host is maintained in an optimized state.

### BACKGROUND OF THE INVENTION

(a) Technical Field of the Invention

The present invention is generally related to computer system monitoring and management, and more particular to a system and method providing integrated management and optimization to the display card and power supply of a computer host.

(b) Description of the Prior Art

Usually, a computer host is equipped with a display card and a power supply. The display card and the power supply have separate application programming interfaces (APIs) so that their respective frequency, temperature, fan status, and power can be monitored from the computer host. However, the display card and the power supply are two distinct products and are produced by different vendors. Those who are familiar with the display cards usually know little about the power supplies, and vice versa.

However, their normal functioning on the computer host is highly related but there is no common API where their management can be integrated together.

### SUMMARY OF THE INVENTION

A major objective of the present invention is to provide a single common application programming interface (API) that integrates the management of a power supply and a display card of a computer host so that the computer host is maintained in an optimized state based on user requirement.

To achieve the objective, a management system for a computer host installed with a power supply and a display card is provided. The management system contains a detection module electrically connected to the power supply and the display card, detecting and providing at least one electrical signal from the power supply and the display card; an operation module electrically connected to the power supply and the display card, adjusting the operation of the power supply and the display card; and a control module electrically connected to the detection module and the operation module, controlling the operation module to adjust the power supply and the display card based on a user requirement and the at least one electrical signal.

With the present invention, a single common API integrates the management of the power supply and the display card simultaneously, which is more convenient and efficient for the user. In addition, the computer host is maintained in an optimized state at all times through autonomous detection, proactive feedback, and self-adjustment.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a computer host under a management system according to an embodiment of the present invention.

FIG. 2 is a functional block diagram showing the management system of FIG. 1.

FIG. 3 is a flow diagram showing the steps of a management method according to an embodiment of the present invention.

FIG. 4 is a schematic diagram showing a screen presented by a display unit of the management system of FIG. 1.

FIG. 5 is a schematic diagram showing another screen presented by a display unit of the management system of FIG. 1.

FIG. 6 is a perspective diagram showing a computer host under a management system according to another embodiment of the present invention.

FIG. 7 is a functional block diagram showing the management system of

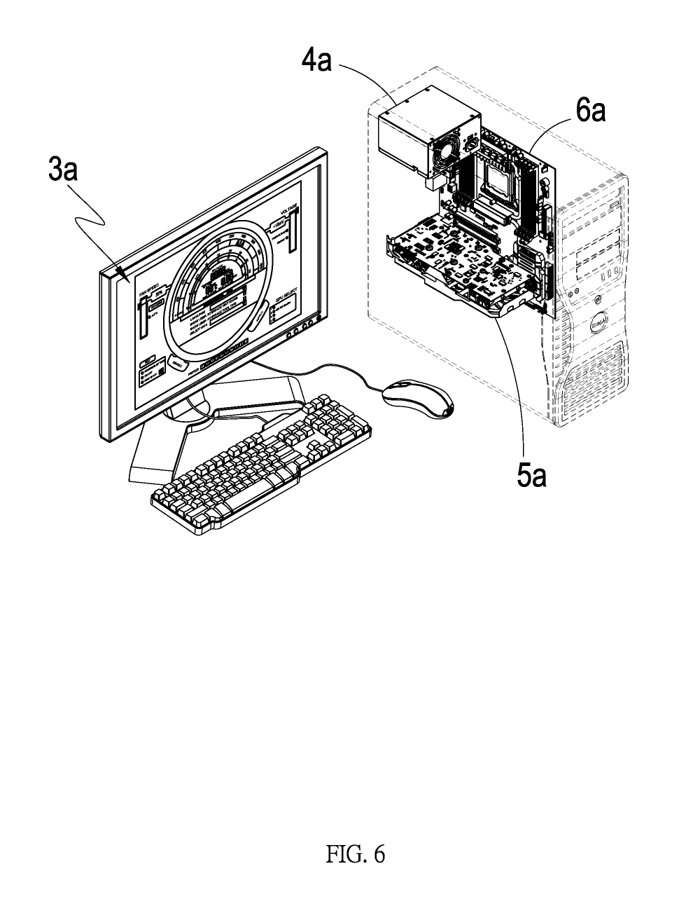

FIG. 6.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

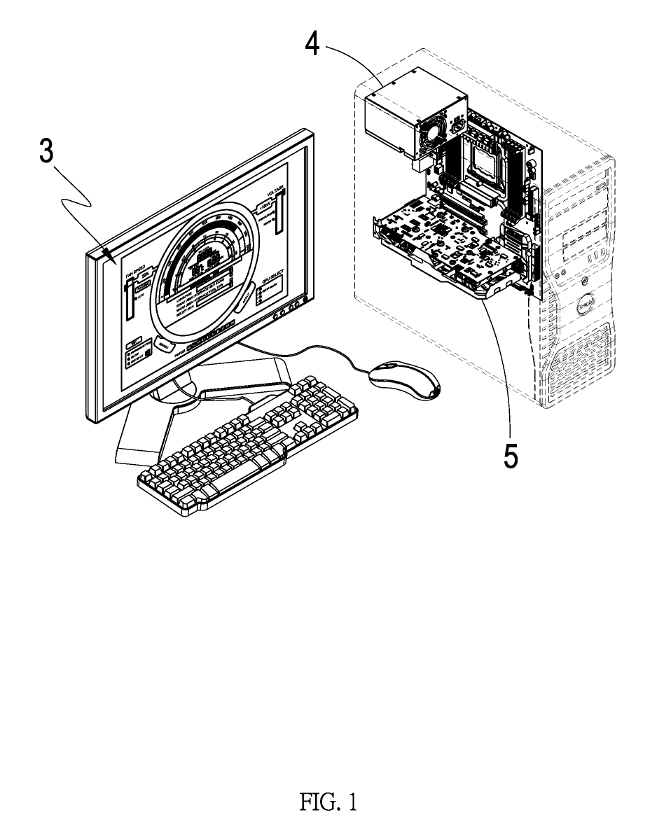

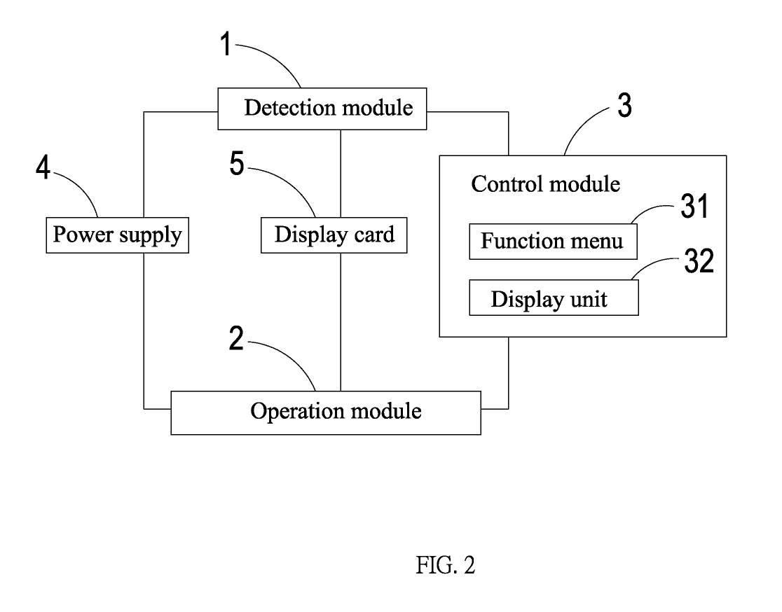

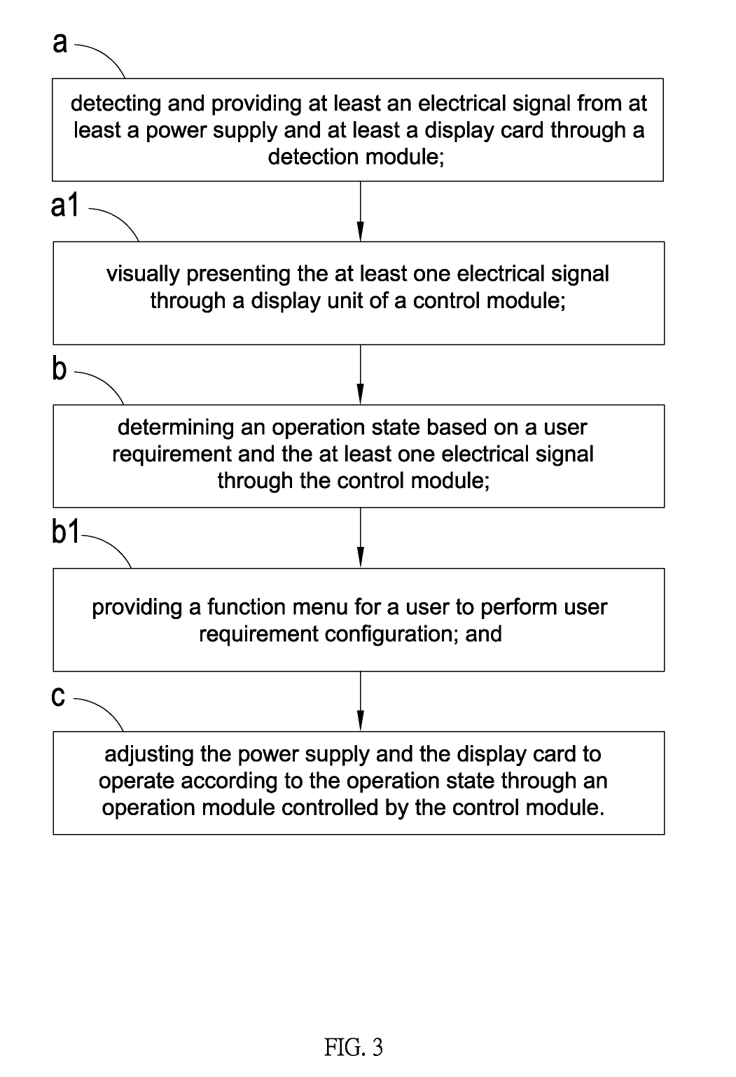

As shown in FIGS. 1 to 3, a management system for a computer host according to an embodiment of the present invention contains the following components.

A detection module 1 is electrically connected to a power supply 4 and a display card 5, both installed inside the computer host. The detection module 1 detects and provides various electrical signals from the power supply 4 and the display card 5, including at least one of a frequency signal, a temperature signal, a voltage signal, a fan speed signal, a power signal, and a current load signal.

An operation module 2 is electrically connected to the power supply 4 and the display card 5 for adjusting the operation of the power supply 4 and display card 5.

A control module 3 is electrically connected to the detection module 1 and the operation module 2. The control module 3, based on user requirement and the various electrical signals, controls the operation module 2 to adjust the power supply 4 and the display card. The control module 3 contains a function menu 31 through which a user can perform requirement configuration, and a display unit through which the various electrical signals are visually presented.

A management method for a computer host according to an embodiment of the present invention contains the following steps:

(a) detecting and providing at least an electrical signal from at least a power supply 4 and at least a display card 5 through a detection module 1;

(a1) visually presenting the at least one electrical signal through a display unit 32 of a control module 3;

(b) determining an operation state based on a user requirement and the at least one electrical signal through the control module 3;

(b1) providing a function menu 31 for a user to perform user requirement configuration; and

(c) adjusting the power supply 4 and the display card 5 to operate according to the operation state through an operation module 2 controlled by the control module 3.

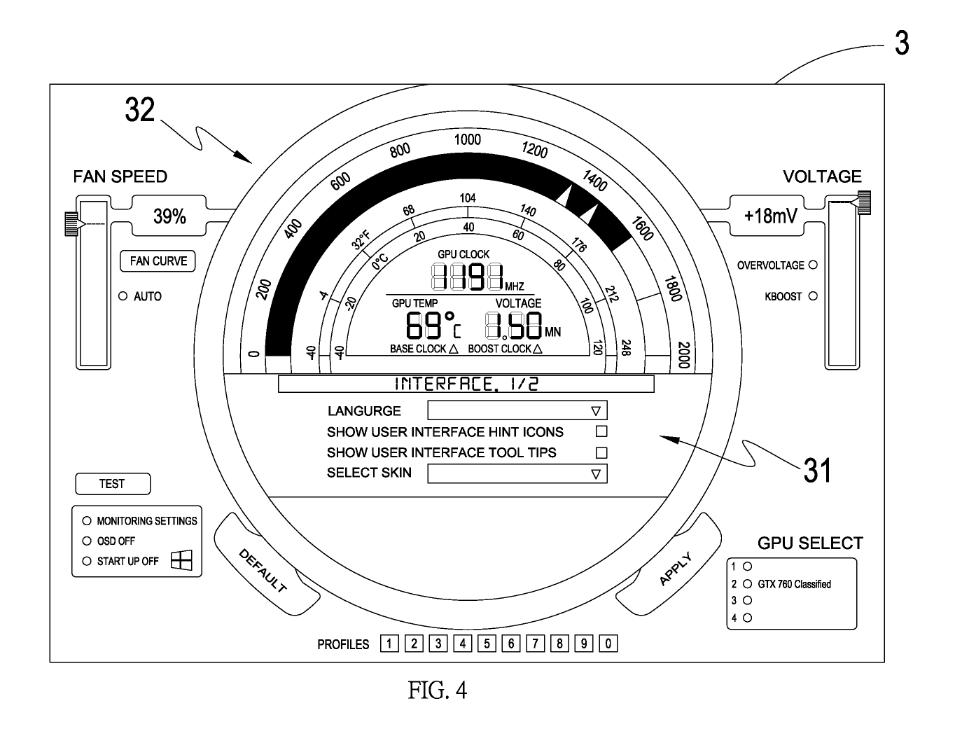

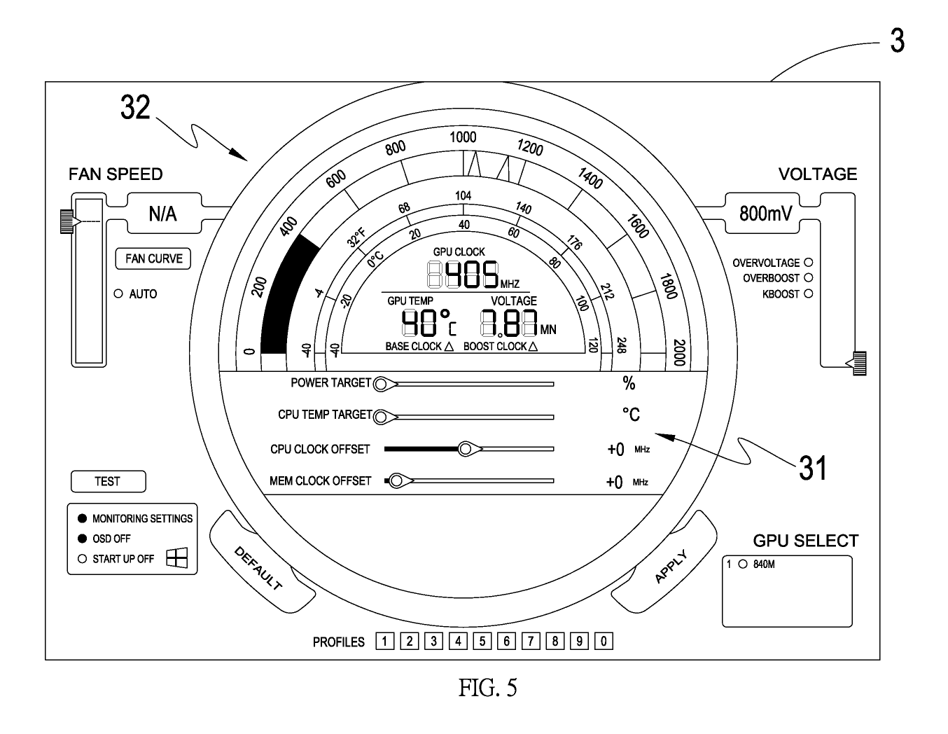

As shown in FIGS. 1 to 5, the control module 3 provides a common application programming interface (API). The various electrical signals detected from the power supply 4 and the display card 5 and provided by the detection module 1 is displayed in real time through the display unit 32. A user therefore can learn the current status of the power supply 4 and the display card 5. The user then can select a desired operation through the function menu 31. For example, the user can choose to overclocking the display card 5, or running the display card 5 in idle speed, in full speed, in a power saving mode, or scheduling a task, etc. Based on the user selection and the various electrical signals from the power supply 4 and the display card 5, the control module 3 calculates and determines an optimized operation state for the power supply 4 and the display card 5 that is most conforming to the user selection. The control module 3 then instructs the operation module 2 to adjust the power supply 4 and the display card 5 so that they operate in the optimized state. For example, if the user selects overclocking the display card 5, the detection module 1 not only collects the frequency, temperature, voltage, fan speed, etc. from the display card 5, but also collects the temperature, voltage, power, etc. from the power supply 4. Then, the control module 3 evaluates the above information collected by the detection module 1, and determines how the display card 5 and the power supply 4 should be adjusted respectively so as to operate in an optimal state closest to the user selection. For example, the control module 3 may determine that the power of the power supply 4 has to be increased, its fan speed has to be increased, and overcurrent protection has to be turned on, etc. The control module 3 then instructs the operation module 2 to adjust the display card 5 and the power supply 4 accordingly. Therefore, the present invention provides integrated monitor and management to the power supply 4 and the display card 5 to achieve optimized operation. Please note that, during the operation of the computer host, the detection module 1 continuously collects the various electrical signals from the power supply 4 and the display card 5 and feedbacks to the control module 3. The control module 3 therefore will dynamically adjust the operation of the display card 5 and the power supply 4 so that they can continue to operate in the optimized state.

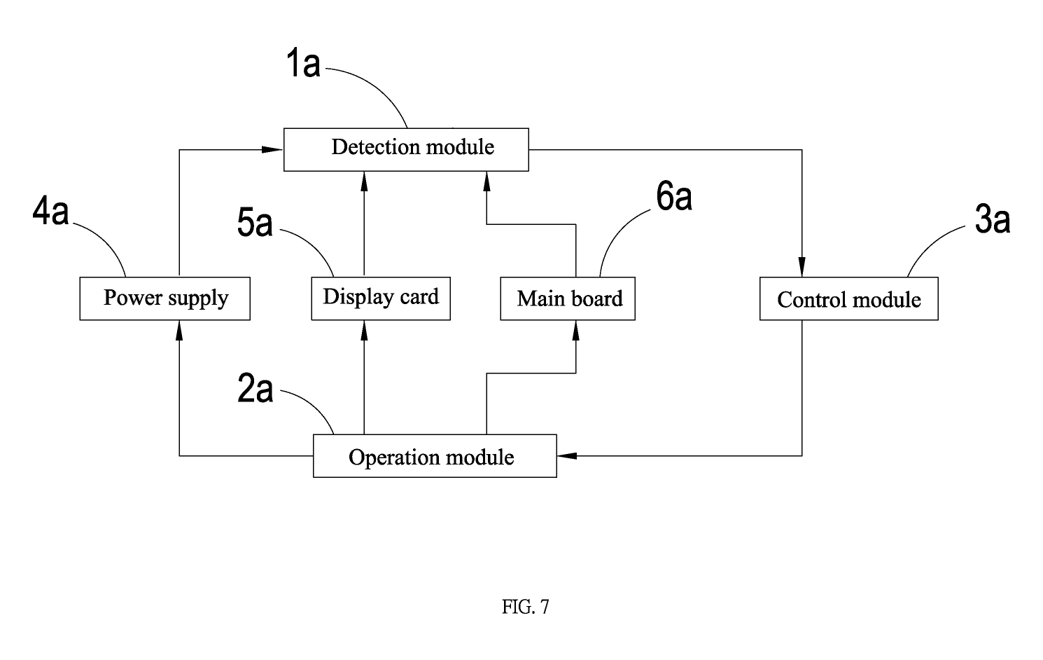

As shown in FIGS. 6 and 7, in addition to a display card 5a and a power supply 4a, the present invention further integrates the management of a main board 6a of the computer host. Similar to what is described above, a detection module 1a also collect electrical signals from the main board 6a, a control module 3a determines an optimized operation state for the power supply 4a, the display card 5a, and the main board 6a through an operation module 2a.

Compared to the prior art, the present invention provides the following improvements.

Firstly, a single common API integrates the management of the power supply 4a, the display card 5a, and the main board 6a, simultaneously, which is more convenient and efficient for the user.

Secondly, the computer host is maintained in an optimized state at all times through autonomous detection, proactive feedback, and self-adjustment.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A management system for a computer host installed with a power supply, a display card, and a main board, comprising:
a detection module electrically connected to the power supply and the display card, detecting and providing at least one electrical signal from the power supply and the display card;
an operation module electrically connected to the power supply and the display card, adjusting the operation of the power supply and the display card; and
a control module electrically connected to the detection module and the operation module, controlling the operation module to adjust the power supply and the display card based on a user requirement and the at least one electrical signal.

2. The management system according to claim 1, wherein the control module comprises a function menu through which a user performs requirement configuration.

3. The management system according to claim 1, wherein the control module comprises a display unit visually presenting the at least one electrical signal.

4. The management system according to claim 1, wherein the main board is electrically connected to the detection module and the operation module; the detection module further detects and provides at least one electrical signal from the main board; the operation module further adjusts the operation of the main board; and the control module further controls the operation module to adjust the main board.

5. The management system according to claim 1, wherein the at least one electrical signal is one of a frequency signal, a temperature signal, a voltage signal, a fan speed signal, a power signal, and a current load signal.

6. The management system according to claim 2, wherein the at least one electrical signal is one of a frequency signal, a temperature signal, a voltage signal, a fan speed signal, a power signal, and a current load signal.

7. The management system according to claim 3, wherein the at least one electrical signal is one of a frequency signal, a temperature signal, a voltage signal, a fan speed signal, a power signal, and a current load signal.

8. The management system according to claim 4, wherein the at least one electrical signal is one of a frequency signal, a temperature signal, a voltage signal, a fan speed signal, a power signal, and a current load signal.

9. A management method for a computer host installed with a power supply, a display card, and a main board, comprising the steps of:
detecting at least an electrical signal from at least a power supply and at least a display card through a detection module electrically connected to the power supply and the display card;
determining an operation state based on a user requirement and the at least one electrical signal through a control module electrically connected to the detection module; and
adjusting the power supply and the display card to operate according to the operation state through an operation module electrically connected to the power supply, the display card, and the control module under the control of the control module.

10. The management method according to claim 9, further comprising the step of visually presenting the at least one electrical signal through a display unit of the control module.

11. The management method according to claim 9, further comprising the step of providing a function menu for a user to perform user requirement configuration.

12. The management method according to claim 9, wherein the main board is electrically connected to the detection module and the operation module; the detection module further detects and provides at least one electrical signal from the main board; the operation module further adjusts the operation of the main board; and the control module further controls the operation module to adjust the main board.

13. The management method according to claim 9, wherein the at least one electrical signal is one of a frequency signal, a temperature signal, a voltage signal, a fan speed signal, a power signal, and a current load signal.

14. The management method according to claim 10, wherein the at least one electrical signal is one of a frequency signal, a temperature signal, a voltage signal, a fan speed signal, a power signal, and a current load signal.

15. The management method according to claim 11, wherein the at least one electrical signal is one of a frequency signal, a temperature signal, a voltage signal, a fan speed signal, a power signal, and a current load signal.

16. The management method according to claim 12, wherein the at least one electrical signal is one of a frequency signal, a temperature signal, a voltage signal, a fan speed signal, a power signal, and a current load signal.
